(19) United States
(12) Patent Application Publication
(10) Pub. No.: US 2009/0254329 A1
(43) Pub. Date: Oct. 8, 2009

(54) METHOD FOR VIRTUALIZATION OF INPUT DEVICES FOR PARALLEL EXECUTION OF TEST AUTOMATION SCRIPTS

(75) Inventor: Rajesh Pravin Thakkar, Bangalore (IN)

Correspondence Address: ZILKA-KOTAB, PC- IBMS, P.O. BOX 721120, SAN JOSE, CA, 95172-1120, US

(73) Assignee: International Business Machines Corporation, Armonk, NY (US)

(21) Appl. No.: 12/062,370

(22) Filed: Apr. 3, 2008

(51) Int. Cl. G06F 17/50

(52) U.S. Cl. 703/13

(57) ABSTRACT

A method in one embodiment includes generating several test automation scripts, each test automation script being generated by methodology comprising: recording interactions with a graphical user interface of an application under test, some of the interactions including input from a pointer, some of the interactions including input from a keyboard; recording the interactions; and storing the interactions in a test automation script. The method further includes, on a single computing device: executing multiple of the generated test automation scripts in parallel, each of the scripts interacting with a separate instance of one of the applications under test; and simulating a virtual pointer and a virtual keyboard for each of the test automation scripts being executed.

### BACKGROUND

The present invention relates to software test automation scripts, and more particularly, this invention relates to optimizing software test automation scripts.

In general, the execution of graphic user interface (GUI) automation test scripts is implemented by playing back the test script on one or more machines with each machine executing a sequential set of scripts. The sequential execution of scripts is mandated since the script playback utilizes a mouse pointer and keyboard to click on GUI elements and enter data. A single test script may have numerous blocking conditions due to network, disk, and other conditions such as slow device access, etc. Thus, for most types of applications being tested, testing machines are highly underutilized due to the constraint of sequential execution of the test scripts.

### SUMMARY

A method in one embodiment includes generating several test automation scripts, each test automation script being generated by methodology comprising: recording interactions with a graphical user interface of an application under test, some of the interactions including input from a pointer, some of the interactions including input, from a keyboard; recording the interactions; and storing the interactions in a test automation script. The method further includes, on a single computing device: executing multiple of the generated test automation scripts in parallel, each of the scripts interacting with a separate instance of one of the applications under test; and simulating a virtual pointer and a virtual keyboard for each of the test automation scripts being executed.

Other aspects, advantages and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWING

FIG. 1 shows a method for visualization of input devices for parallel execution of test automation scripts, in accordance with one embodiment.

FIG. 2 shows an example of the visualization of input devices on a single system.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

In one general embodiment, a method is provided. In operation, several test automation scripts are generated, each test automation script being generated by methodology comprising: recording interactions with a graphical user interlace of an application under test, some of the interactions including input from a pointer, some of the interactions including input from a keyboard; recording the interactions; and storing the interactions in a test automation script. Furthermore, on a single computing device, multiple of the generated test automation scripts are executed in parallel, each of the scripts interacting with a separate instance of one of the applications under test and a virtual pointer and a virtual keyboard are simulated for each of the test automation scripts being executed.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

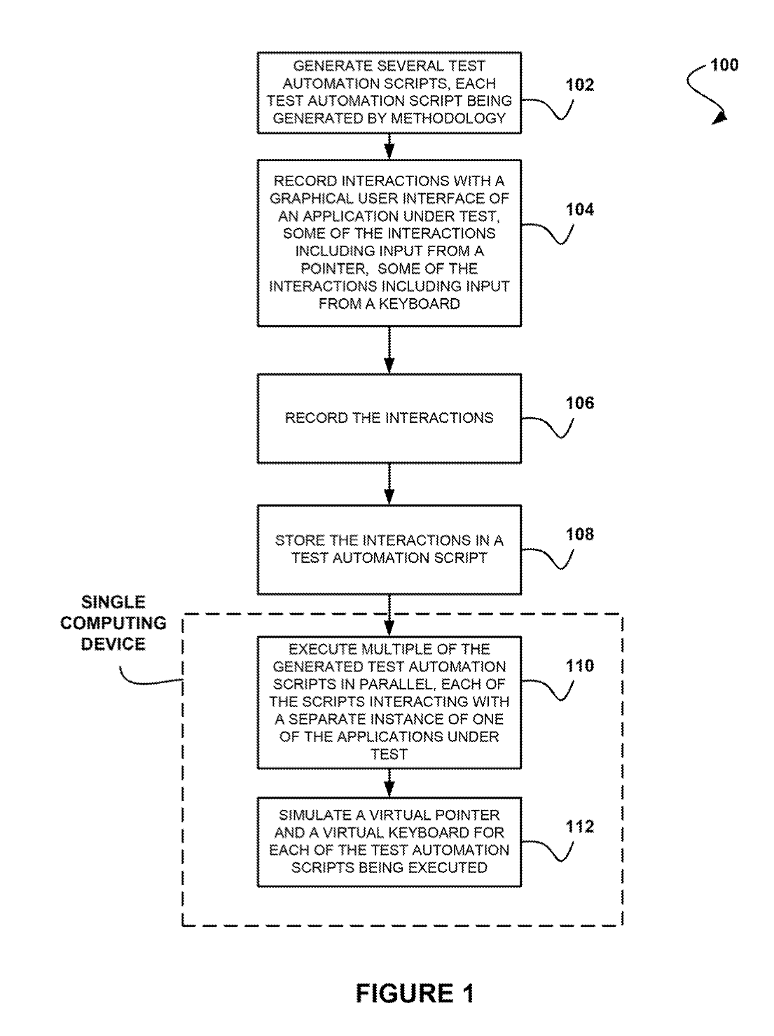

FIG. 1 shows a method 100 for visualization of input devices for parallel execution of test automation scripts, in accordance with one embodiment. As shown, several test automation scripts are generated, each test automation script being generated by a methodology. See operation 102.

As shown further, the methodology for generating each test message includes recording interactions with a graphical user interface of an application under test, some of the interactions including input from a pointer, some of the interactions including input from a keyboard. See operation 104. Additionally, the methodology for generating each test message includes recording the interactions. See operation 106. Still yet, the methodology for generating each test message includes storing the interactions in a test automation script. See operation 108.

Furthermore, multiple of the generated test automation scripts are executed in parallel, each of the scripts interacting with a separate instance of one of the applications under test. See operation 110. Additionally, a virtual pointer and a virtual keyboard are simulated for each of the test automation scripts being executed. See operation 112. It should be noted that operations 110 and 112 may be implemented on a single computing device.

In this way, the method 100 allows for visualization of input devices (e.g. a mouse and keyboard, etc.) enabling the execution of multiple scripts in parallel on a single machine, resulting in performance improvement of the order of two to four times, that of a conventional configuration.

For example, current operating systems base their graphical user interfaces (GUIs) on the concept of windows. A user can work with one window at a time using one mouse and/or keyboard. Such an interaction for user interfaces may be logical for human interaction with machines in some cases, but in a scenario where an application needs to interact with the GUI of another application, this single mouse/keyboard is a major limitation. Thus, it is desirable to allow multiple instances of the same or different applications to simultaneously interact with the GUI of other application(s) running on the same machine.

As an option, a GUI based automation tool may record the GUI interactions (e.g. mouse and keyboard interactions, etc.) and store these interactions as a script. The playback of the script may launch the application under test (AUT) and recreate the recorded GUI events. In one case, this class of application may be unique in that one application interacts with the GUI of another by recreating the mouse and keyboard interactions. Thus, two different applications may interact and playback an activity. In this way, a large number of recordings may be played back sequentially or parallel.

For a large number of desktop and web/network applications, a significant percentage of processing time (e.g. CPU time, etc.) is idle due to the blocking of calls by the application to access resources such as disks, and networks, etc. Thus, significant performance improvement may be gained (e.g. 2 to 4 times) by executing scripts in parallel, each interacting with a separate instance of the AUT.

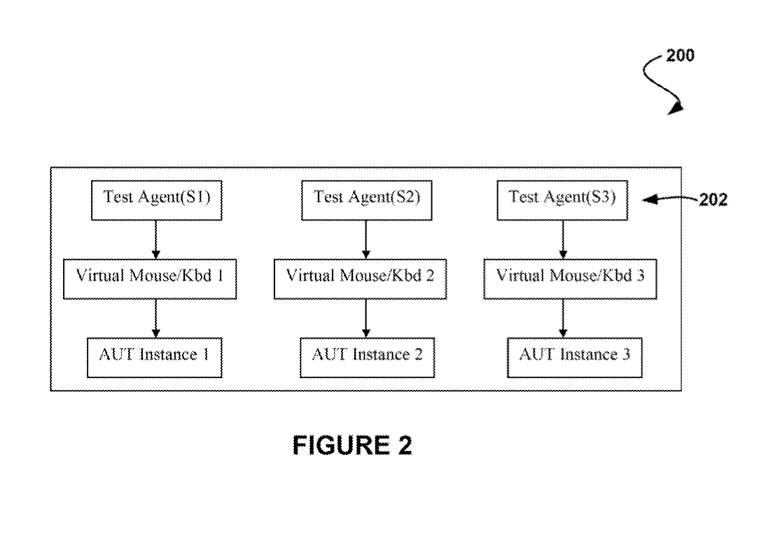

FIG. 2 shows an example 200 of the virtualization of input devices on a single system. As shown, each test agent 202 executes a script such as S1, S2, and S3. Also, the agent may create and/or simulate a virtual mouse and/or keyboard for an AUT instance. Since there are no physical input devices involved, contentions for mouse, keyboard, or focus do not arise.

While running the test, automation scripts on a single machine (e.g. a desktop, laptop, etc.) or on a server farm, the physical input devices should have no relevance. However, the captured GUI interactions may be reproduced authentically. Taking the example of a simple mouse click, this mouse click may cause two events to be generated and sent to the application. For example, a mouse down event and a mouse up event may be generated.

In operation, an event queue may hold the input device events, which may then be picked up by an event processing loop. For each event, the event processing loop may call the appropriate event handler method/function in the target application code. To visualize the input devices, directly calling event handlers in the application code may be used to simulate occurrence of events.

This technique may be implemented by first discovering which handlers the application has implemented. This may be accomplished differently for different GUI frameworks. For example, in the case of Java, the reflection application program interface (API) may be used to achieve this. For Win32, the registered callbacks should be discovered. Furthermore, events may be created/instantiated and programmatically inserted into the event queue. This technique is possible on APIs available in various GUI frameworks (e.g. MFC, .Net, Java/Swing, Win32, QT, ActiveX, etc.). In this way, input devices of a system may be visualized, allowing the applications to freely interact with the GUIs of multiple other applications in parallel.

It should be noted that, the invention can take the form of an embodiment containing both hardware and software elements. In one embodiment, the invention may be implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semi conductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method, comprising:
generating several test automation scripts, each test automation script being generated by methodology comprising:
recording interactions with a graphical user interface of an application under test, some of the interactions including input from a pointer, some of the interactions including input from a keyboard;
recording the interactions; and
storing the interactions in a test automation script; and
on a single computing device:
executing multiple of the generated test automation scripts in parallel, each of the scripts interacting with a separate instance of one of the applications under test; and
simulating a virtual pointer and a virtual keyboard for each of the test automation scripts being executed.
